(19) United States
(12) Patent Application Publication
(10) Pub. No.: US 2006/0093777 A1
(43) Pub. Date: May 4, 2006

(54) Photoluminescent felt materials, photoluminescent turntable slipmats, and methods of making the same

(76) Inventors: Shannon Marie Handy, Chicago, IL (US); Ronnie Derek McGhee, Chicago, IL (US)

Correspondence Address: RYNDAK & SURI LLP, 200 W MADISON STREET, SUITE 2100, CHICAGO, IL, 60602, US

(21) Appl. No.: 10/976,972

(22) Filed: Oct. 29, 2004

(51) Int. Cl. B32B 3/02

(52) U.S. Cl. 428/64.1; 428/66.6

(57) ABSTRACT

Photoluminescent felt materials are provided comprising a felt substrate sheet having a first and a second surface and a photoluminescent component incorporated with to the felt substrate. Additionally, photoluminescent turntable slipmats are provided comprising a disc of a flexible substrate material, preferably a felt substrate material, and a photoluminescent component incorporated with the substrate. The photoluminescent materials and turntable slipmats preferably include visual indicia on one of the surfaces of the photoluminescent slipmat, such as designs, logos, contact information, business/band names, or the like. Methods of making the photoluminescent felt materials and photoluminescent turntable slipmats are further provided.

### FIELD OF THE INVENTION

The present invention is directed to novel photoluminescent felt materials and products. More particularly, the present invention relates to (1) photoluminescent felt materials; (2) photoluminescent turntable slipmats; (3) and methods of making the photoluminescent felt materials and photoluminescent turntable slipmats.

### BACKGROUND OF THE INVENTION

Numerous felt materials are known and used for various purposes. Generally, felt materials consist a non-woven fabric made from wool, hair, fur, and/or other certain manufactured fibers, where the fibers are locked together in a process utilizing heat, moisture, and pressure to form a compact material. Such felt materials come in various colors of felt used for a number of different practical and decorative purposes, such as, for example, the surfaces of car interiors, safety products, decorative craft goods, and more particularly disc-jockey (“DJ”) turntable slipmats. Conventionally, these felt materials are limited in selection to only a narrow range of colors, which require light to be visible.

As such, conventional felt materials are of little use in relatively dark environments where the materials would be useful to provide information or to provide a unique “glow in the dark” appearance. For example, events where disk-jockeys (“DJ's”) play music often have a dark setting and thus DJ's find it desirable to improve the aesthetics of such an environment by using photoluminescent or “glow in the dark” materials.

Often, DJ's also frequently use turntable slipmats which are placed over the spindle of the turntable, thereby decorating the turntable when not in use. When in use, the slipmat reduces motor rumble of the turntable by providing a smooth, non-scratching surface over which the phonorecord may spin. The mat also enables the user to hold a record steady while permitting the turntable to rotate without damage to the record. As these slipmats are widely used in dark environments, it would be desirable to provide a slipmat with a more original appearance and which can also display information when the turntable is not in use while still providing a non-scratching, smooth surface when in use.

Accordingly, there is a need for novel photoluminescent felt materials, including but not limited to novel photoluminecent turntable slipmats, and methods of making the same.

### SUMMARY OF THE INVENTION

While this invention is susceptible of embodiment in many different forms, there are shown in the drawings and described in detail herein, several specific embodiments with the understanding that the present disclosure is to be considered as exemplifications of the principles of the invention and is not intended to limit the invention to the embodiments illustrated.

In accordance with the present invention, a plurality of different felt materials are provided which are “photoluminescent.” By “photoluminescent,” it is meant the material has the ability to become luminescent upon exposure to visible light. Such novel felt materials may be used for a wide variety of applications, including but not limited to car interiors, safety products, decorative craft goods, and disc-jockey (“DJ”) turntable slipmats.

In accordance with one aspect of the present invention, a number of novel felt materials having photoluminescent properties are provided. Each photoluminescent-felt material includes a felt substrate sheet having a first and a second surface and a photoluminescent component incorporated with the felt substrate sheet. By “incorporated with the felt substrate sheet,” it is meant that the photoluminescent component may be applied to a surface of the felt substrate, laminated to a surface of the substrate, impregnated within the felt substrate, or may be an integral component which forms the felt substrate sheet, such as by being needle punched together with another component to form the felt substrate sheet, or otherwise directly or indirectly affixed to the felt substrate sheet.

In accordance with another aspect of the present invention, the photoluminescent component may be any one of a number of different materials. For example, the photoluminescent component may be: 1) a photoluminescent fiber; preferably needle-punched with a natural fiber to form the felt substrate sheet; 2) a photoluminescent film adhered to the felt substrate sheet; 3) a photoluminescent pigment laminated with or impregnated within the felt substrate sheet; or 4) a photoluminescent paper laminated to the felt substrate sheet. When the photoluminescent component is a photoluminescent fiber, the photoluminescent fiber may be one of polyester, polypropylene, nylon, or any other suitable material which can maintain a photoluminescent pigment therein or thereon.

In accordance with another aspect of the invention, visual indicia such as logos, designs, a company's name, address information, website information, and telephone number(s) may be provided on one or both of the surfaces of the felt substrate sheet by any suitable method known in the art, preferably by sublimating the visual indicia on the substrate.

In accordance with yet another aspect of the present invention, a photoluminescent slipmat is provided comprising a disc of a flexible substrate material adapted to be placed over a spindle of a turntable and a photoluminescent component incorporated with the substrate. By “incorporated with the substrate,” it is meant that the photoluminescent component may be applied to a surface of the substrate, laminated to a surface of the substrate, impregnated within the substrate, or may be an integral component which forms the substrate, such as by being needle punched together with another component to form the substrate, or otherwise directly of indirectly affixed to the substrate. Typically, the disc has an aperture such that the disc may be placed over the spindle of the turntable, but may include any other structure such as an “X-shaped” cut-out for placing the disc over the spindle.

In accordance with yet another aspect of the invention, the flexible substrate comprises a felt substrate and the photoluminescent component is incorporated with the felt substrate. The photoluminescent component may be: 1) a photoluminescent fiber, which is preferably needle-punched with a natural fiber to form the felt substrate; 2) a photoluminescent film laminated to the felt substrate; 3) a photoluminescent pigment, laminated with or impregnated within the felt substrate; or 4) a photoluminescent paper laminated to the felt substrate. When the photoluminescent component is a photoluminescent fiber, the photoluminescent fiber may be one of polyester, polypropylene, nylon, or any other suitable material which can maintain a photoluminescent pigment therein or thereon.

In another embodiment of the photoluminescent turntable slipmat, the flexible substrate includes a single layer of a photoluminescent film.

In accordance with yet another aspect of the invention, visual indicia such as logos, designs, a band's name, company's name, address information, website information, and telephone numbers are provided on one or both of the surfaces of the flexible substrate of the photoluminescent slipmat.

In accordance with yet another aspect of the present invention, the photoluminescent slipmat may include a coating of silicone or any other suitable material on at least one surface of the slipmat, typically the bottom surface, of the photoluminescent turntable slipmat, for reducing friction between the photoluminescent mat and the turntable when in use.

In accordance with yet another aspect of the present invention, a method of making a photoluminescent felt material is provided comprising:

providing a felt substrate sheet having a top surface and a bottom surface; and

incorporating a photoluminescent component with the felt substrate sheet to produce a sheet of photoluminescent felt material.

In one embodiment, the photoluminescent component is a photoluminescent film and the incorporating comprises adhering the photoluminescent film to the felt substrate sheet using any suitable adhesive known in the art. The felt substrate sheet may be any one of a nylon, polypropylene, polyester, or cotton non-woven felt substrate, or alternatively any other suitable material.

In yet another embodiment, the photoluminescent component is a photoluminescent pigment, and the incorporating comprises laminating the photoluminescent pigment to the substrate. The substrate may be any one of a nylon, polypropylene, polyester, or cotton non-woven felt substrate, or alternatively any other suitable material. In this embodiment, the photoluminescent component may comprise a mixture of a photoluminescent pigment and a resin.

In still another embodiment, the photoluminescent component comprises a photoluminescent pigment, and the step of incorporating comprises forming a mixture of the photoluminescent pigment and a solvent, impregnating the substrate within the mixture, preferably by immersing the felt substrate in the solvent, and evaporating the solvent.

In still another embodiment, the photoluminescent component comprises photoluminescent paper and the step of incorporating comprises laminating the photoluminescent paper to the felt substrate.

In another aspect of the present invention, the method includes cutting the formed photoluminescent sheet material into at least one photoluminescent disc adapted to be used with a turntable. Typically, the photoluminescent disc includes an aperture for placing the disc over the spindle of the turntable.

In yet another aspect of the invention, visual indicia such as company and/or marketing information, logos, and/or designs may be provided on at least one of the top and bottom surfaces of the substrate by any suitable method known in the art, preferably by sublimination.

In still another aspect of the present invention, another method of making a photoluminescent felt material is provided comprising providing a first fiber and a second fiber having a photoluminescent component; and needle punching the first fiber and second fiber to form a sheet of photoluminescent felt material.

In still another aspect of the present invention, there is provided a method of making a photoluminescent turntable slipmat comprising providing a disc of a flexible substrate and incorporating a photoluminescent material with the flexible substrate.

In one embodiment, the flexible substrate comprises a felt substrate and the photoluminescent component comprises a photoluminescent film. The step of incorporating comprises adhering the photoluminescent film to the felt material using any suitable adhesive known in the art.

In still another embodiment, the photoluminescent component comprises a photoluminescent pigment and the step of incorporating comprises forming a mixture of the photoluminescent pigment and a solvent; impregnating the substrate with the mixture; and evaporating the solvent.

In still another embodiment, the photoluminescent component is a photoluminescent paper and the substrate comprises a felt material. The step of incorporating comprises laminating the photoluminescent paper to the substrate.

In still another embodiment, the photoluminescent component comprises a photoluminescent pigment, and the step of incorporating comprises applying the photoluminescent pigment on at least one of the top and bottom surfaces of the felt material and laminating the photoluminescent pigment to the felt material. The applying of the photoluminescent pigment may be performed by spraying or otherwise dispensing the photoluminescent pigment onto a surface of the substrate. Alternatively, the applying may be performed by any other suitable method known in the art. In this embodiment, the photoluminescent component may comprise a mixture of a photoluminescent pigment and a resin.

In another aspect of the present invention, another method of making a photoluminescent slipmat is provided comprising providing a first fiber and a second fiber having a photoluminescent component and needle punching the first fiber and the second fiber to form a disc of photoluminescent material.

In yet another aspect of the present invention, the above methods of making a photoluminescent slipmat include providing visual indicia on at least one of a top and bottom surfaces of said substrate. The visual indicia may include for example a band's name, company's name, address information, and telephone numbers on a surface of the flexible substrate.

In yet another aspect of the present invention, the method comprises providing a novel relatively frictionless surface on at least one of the top and bottom surfaces, and preferably the bottom surface, of the turntable slipmat for reducing friction between the photoluminescent mat and a turntable when in use. Typically, the providing of the relatively frictionless surface is accomplished by subjecting the at least one surface to heat at a temperature above the melting point of the felt substrate material for a sufficient period of time to form a relatively frictionless surface, which may have the appearance of a glaze, on at least one of the top and bottom surfaces of the turntable slipmat.

In still another novel aspect of the present invention, the method comprises substantially coating at least one surface of the photoluminescent slipmat with silicone or any other suitable material for reducing friction between the photoluminescent mat and a turntable when in use.

Other advantages and features of the invention will become apparent from the following description and from reference to the drawings.

### BRIEF DESCRIPTION OF THE DRAWINGS

FIG. 1 is a schematic representation of the different composition of photoluminescent felt materials in accordance with the present invention;

FIG. 2 is a perspective view of a photoluminescent turntable slipmat of the present invention mounted on a turntable;

FIG. 3 is a schematic representation of the different composition of photoluminescent slipmats in accordance with the present invention;

FIG. 4 is a flow chart illustrating methods of making photoluminescent felt materials in accordance with the present invention;

FIG. 5 is a flow chart illustrating another method of making a photoluminescent felt material in accordance with the present invention;

FIG. 6 is a flow chart illustrating methods of making photoluminescent turntable slipmats in accordance with the present invention;

FIG. 7 is a flow chart illustrating another method of making a photoluminescent turntable slipmat in accordance with the present invention;

FIG. 8 is a top elevation view of a sheet of photoluminescent felt material in accordance with the present invention;

FIG. 9 is a fragmentary side elevation view of a photoluminescent felt material in accordance with the present invention;

FIG. 10 is a fragmentary side elevation view of another photoluminescent felt material in accordance with the present invention having a photoluminescent resin layer and a photoluminescent felt layer;

FIG. 11 is a fragmentary side elevation view of yet another photoluminescent felt material in accordance with the present invention having a thermal wax transfer paper layer and a photoluminescent felt layer;

FIG. 12 is a fragmentary side elevation view of still another photoluminescent felt material in accordance with the present invention having a photoluminescent thermal wax transfer paper layer and a felt layer; and

FIG. 13 is a fragmentary side elevation view of still another photoluminescent felt material in accordance with the present invention having a photoluminescent film layer and a felt material later.

### DETAILED DESCRIPTION

In accordance with the present invention, a plurality of different photoluminescent felt materials, photoluminescent turntable slipmats and methods of making the photoluminescent felt materials and turntable slipmats are provided which are “photoluminescent,” or “glow in the dark” in nature. By “photoluminescent,” it is meant the material has the ability to become luminescent upon exposure to visible light. Such novel photoluminescent felt materials may used for a wide variety of applications, including but not limited to, car interiors, safety products, decorative craft goods and more particularly disc-jockey (“DJ”) turntable slipmats. Typically, a sheet of photoluminescent felt material in accordance with the present invention may be photoluminescent for a period of up to about 12 hours once fully charged.

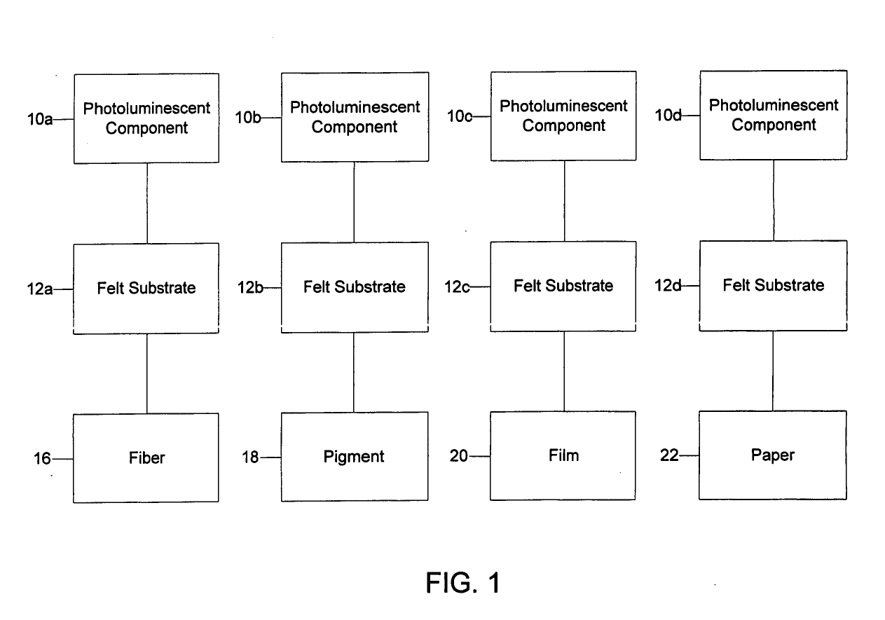

As shown by the schematic representation in FIG. 1, a plurality of different photoluminescent felt materials 10a-d are provided each of which include a felt substrate 12a-d and a photoluminescent component 14a-d incorporated with the felt substrate 12a-d. By “incorporated with the felt substrate sheet,” it is meant that the photoluminescent component may be applied to a surface of the felt substrate, laminated to a surface of the material, impregnated within the felt substrate, or may be an integral component which forms the felt substrate sheet, such as by being needle punched together with another component to form the felt substrate sheet, or otherwise directly of indirectly affixed to the felt substrate sheet. The photoluminescent component may be one of a photoluminescent fiber 16, a photoluminescent pigment 18, a photoluminescent film 20, or photoluminescent paper 22 which is incorporated with the felt substrate by any of the methods disclosed herein, including but not limited to Examples 1-6 below, or alternatively by other suitable method known in the art.

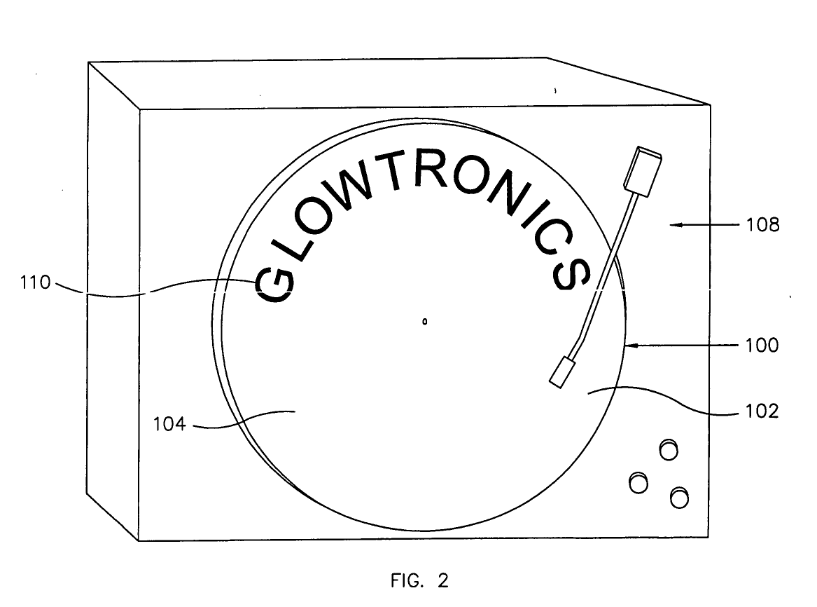

FIG. 2 illustrates a photoluminescent turntable slipmat 100 in accordance with the present invention. Slipmat 100 comprises a disc 102 of a flexible substrate and a photoluminescent component 104 incorporated with the flexible substrate. Disc 102 typically includes an aperture 106 such that the disc can be placed over the spindle of a turntable 108. By “incorporated with the substrate,” it is meant that the photoluminescent component may be applied to a surface of the substrate, laminated to a surface of the substrate, impregnated within the substrate, or may be an integral component which forms the substrate, such as by being needle punched together with another component to form the substrate, or otherwise directly of indirectly affixed to the substrate.

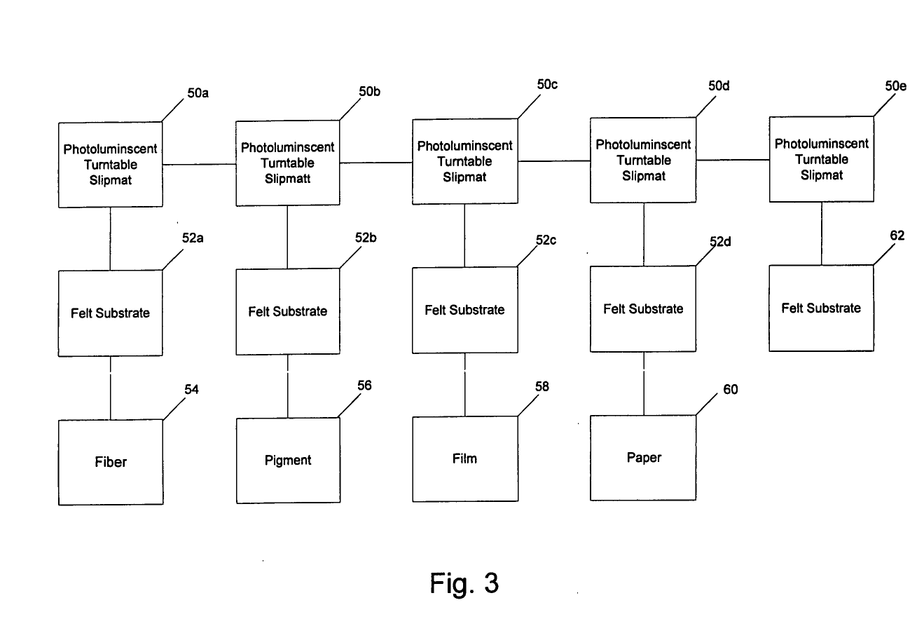

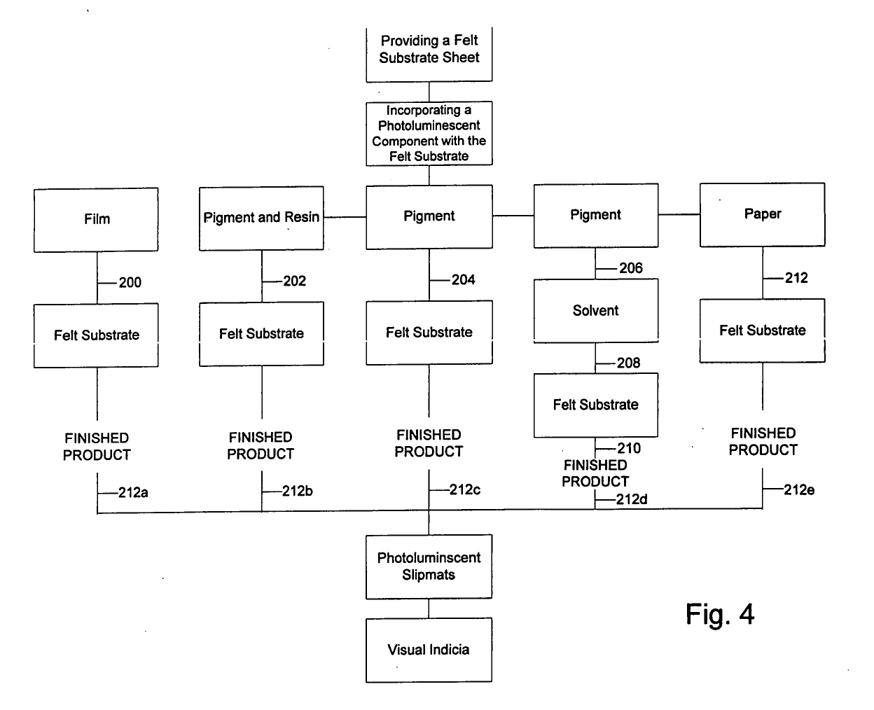

As shown by FIG. 3, the photoluminescent component 50a-e may be one of a photoluminescent fiber, a photoluminescent pigment 52b, a photoluminescent film 58, or photoluminescent paper 60 which is incorporated with a substrate, and preferably a felt substrate 52a-d, by any of the methods disclosed herein, including but not limited to Examples 1-6 below, or alternatively by other suitable method known in the art. Alternatively, photoluminescent turntable slipmat 50e may comprise a photoluminescent film 62.

It is understood that the photoluminescent turntable slipmats in accordance with the present invention may be die-cut from a relatively large sheet of photoluminescent felt material made from any of the methods for making a photoluminescent felt material described herein. Alternatively, the formed sheet of photoluminescent material may be already formed into the shape of a photoluminescent turntable slipmat in accordance with the present invention.

In FIG. 3, a flow chart illustrates the steps involved in making photoluminescent felt materials in accordance with the present invention. The method comprises:

providing a felt substrate sheet having a top surface and a bottom surface; and

incorporating a photoluminescent component with the felt substrate sheet to produce a sheet of photoluminescent felt material.

In one embodiment, the photoluminescent component is a photoluminescent film and the incorporating comprises adhering the photoluminescent film to the felt substrate, shown by stream 200, by any suitable adhesive known in the art. The substrate may be any one of a nylon, polypropylene, polyester, or cotton non-woven felt substrate, or alternatively any other suitable material.

In yet another embodiment, the photoluminescent component is a photoluminescent pigment mixed with a resin, and the incorporating comprises laminating the photoluminescent pigment-resin mixture to the substrate, as shown by stream 202. The substrate may be any one of a nylon, polypropylene, polyester, or cotton non-woven felt substrate, or alternatively any other suitable material.

In yet another embodiment, the photoluminescent component is a photoluminescent pigment and the incorporating comprises laminating the photoluminescent pigment to the substrate, as shown by stream 204. The substrate may be any one of a nylon, polypropylene, polyester, or cotton non-woven felt substrate, or alternatively any other suitable material. In this embodiment, the photoluminescent component may comprise a mixture of a photoluminescent pigment and a resin.

In still another embodiment, the photoluminescent component comprises a photoluminescent pigment, and the step of incorporating comprises forming a mixture of the photoluminescent pigment and a solvent, shown by stream 206, impregnating the felt substrate within the mixture, shown by stream 208, preferably by immersing the felt substrate in the solvent, and evaporating the solvent, shown by stream 210.

In still another embodiment, the photoluminescent component comprises photoluminescent paper and the step of incorporating comprises laminating the photoluminescent paper to the felt substrate, as shown by stream 212.

In another aspect of the invention, the method may include cutting the finished product, which is typically a sheet of photoluminescent material, into at least one photoluminescent disc, a photoluminescent turntable slipmat which is adapted to be used with a turntable, as shown by stream 214. Typically, the die-cut photoluminescent slipmats include an aperture for placing the disc over the spindle of the turntable, as shown by aperture 106 of slipmat 100 in FIG. 2.

Additionally, the method further includes providing visual indicia such as company and/or marketing information, logos, and/or designs may be provided on at least one of the top and bottom surfaces of the felt substrate by any suitable method such as by sublimation as set forth below, shown by stream 216.

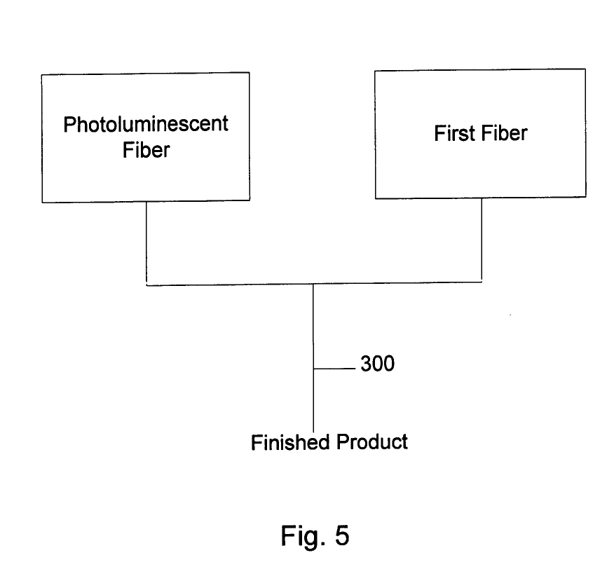

In FIG. 5, a flow chart illustrates another method of making a photoluminescent felt material in accordance with the present invention. The method comprises providing a first fiber, and a second fiber having a photoluminescent component; and needle punching the first fiber and said second fiber to form a sheet of photoluminescent-felt material, shown by stream 300. The first fiber is preferably a cotton fiber, such as cotton or any other suitable material. The second fiber may be one of nylon, polypropylene, polyester, or any other suitable material.

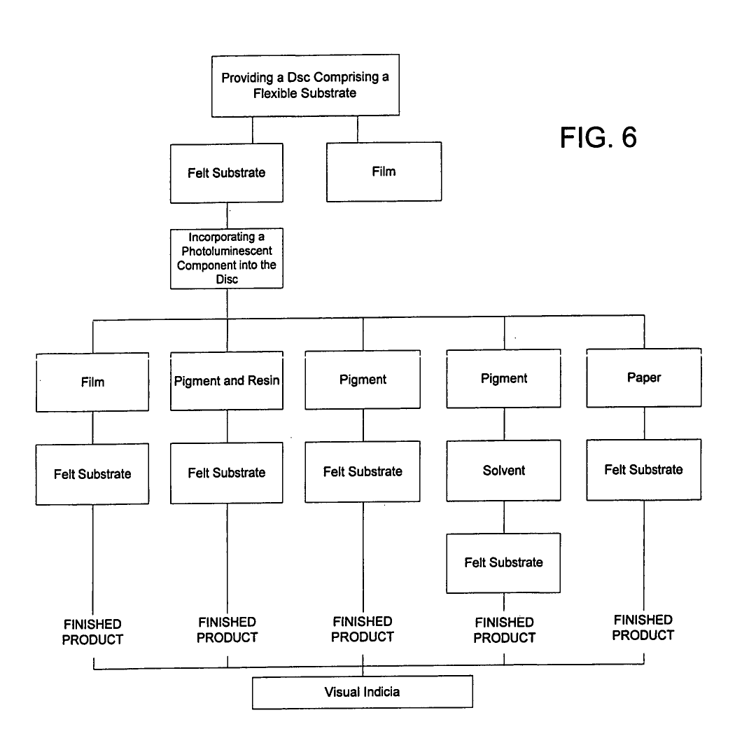

In FIG. 6, a flow chart illustrates a method of making a photoluminescent slipmat in accordance with the present invention. The method comprises providing a disc comprising a flexible substrate and incorporating a photoluminescent component into the disc, shown by stream 400.

In one embodiment, the photoluminescent component is a photoluminescent film, the flexible substrate is a felt substrate, and the incorporating comprises adhering the photoluminescent film to the felt substrate, shown by stream 402, by any suitable adhesive known in the art. The substrate may be any one of a nylon, polypropylene, polyester, or cotton non-woven felt substrate, or alternatively any other suitable material.

In yet another embodiment, the photoluminescent component is a photoluminescent pigment mixed with a resin, the flexible substrate is a felt substrate, and the incorporating comprises laminating the photoluminescent pigment-resin mixture to the substrate, as shown by stream 404. The substrate may be any one of a nylon, polypropylene, polyester, or cotton non-woven felt substrate, or alternatively any other suitable material.

In yet another embodiment, the photoluminescent component is a photoluminescent pigment, the flexible substrate is a felt substrate, and the incorporating comprises laminating the photoluminescent pigment to the substrate, as shown by stream 406. The substrate may be any one of a nylon, polypropylene, polyester, or cotton non-woven felt substrate, or alternatively any other suitable material.

In still another embodiment, the photoluminescent component comprises a photoluminescent pigment, the flexible substrate is a felt substrate, and the step of incorporating comprises forming a mixture of the photoluminescent pigment and a solvent, shown by stream 408, impregnating the felt substrate within the mixture, shown by stream 410, preferably by immersing the felt substrate in the solvent, and evaporating the solvent, as shown by stream 412.

In still another embodiment, the photoluminescent component comprises photoluminescent paper, the flexible substrate is a felt substrate, and the step of incorporating comprises laminating the photoluminescent paper to the felt substrate, as shown by stream 414.

Additionally, any of the above methods of making a photoluminescent turntable slipmat may further include providing visual indicia such as company and/or marketing information, logos, and/or designs may be provided on at least one of the top and bottom surfaces of the flexible substrate disc by any suitable method such as by sublimation as set forth below, shown by stream 416.

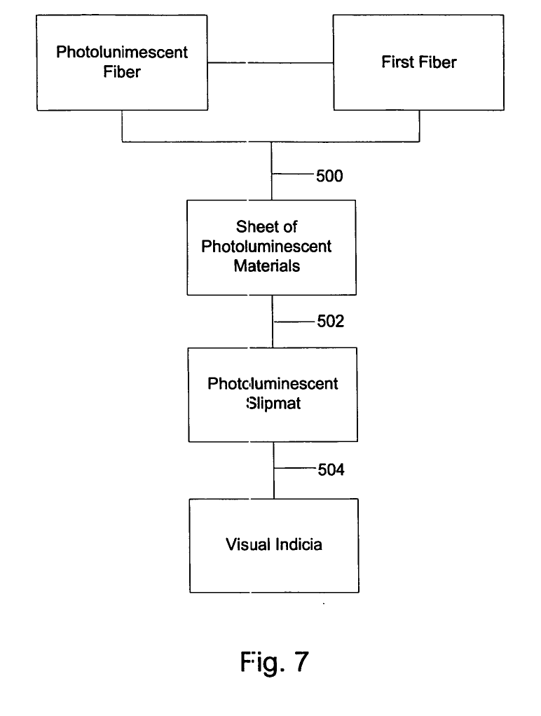

In FIG. 7, a flow chart illustrates another method of making a photoluminescent turntable slipmat in accordance with the present invention. The method comprises providing a first fiber and a second fiber having a photoluminescent component; and needle punching the first fiber and the second fiber to form a sheet of photoluminescent-felt material, shown by stream 500. The first fiber is preferably a cotton fiber, such as cotton or any other suitable material. Thereafter, the sheet is die-cut in the form of a disc to produce a photoluminescent turntable slipmat, shown by stream 502.

In yet another aspect of the present invention, the above methods of making a photoluminescent slipmat include providing visual indicia on at least one of a top and bottom surfaces of the flexible substrate by sublimating process as set forth below. The visual indicia may include for example a band's name, company's name, address information, and telephone numbers on a surface of the felt substrate, shown by stream 504.

The following are examples of embodiments of the inventive method as it may be used to produce a variety of photoluminescent felt materials and products, including but not limited to photoluminescent slipmats.

### EXAMPLE 1

The method of making a photoluminescent material begins with providing a first fiber and a second fiber which is a photoluminescent fiber. The photoluminescent fiber may be one of nylon, polypropylene, polyester, or any other suitable material and the first fiber is preferably a natural fiber of cotton or any other suitable material. The first fiber is preferably a natural fiber, such as a cotton fiber. Typically, each photoluminescent fiber has a denier size of between about 3 and 10 and is preferably activated by strontium aluminate. Alternatively, any other suitable component providing photoluminescent properties may be used. It is contemplated that the particle size of the strontium aluminate correlates with the amount of its luminescence. For example, generally, the smaller the particle size of the strontium aluminate, the smaller the amount of luminescence the material can produce.

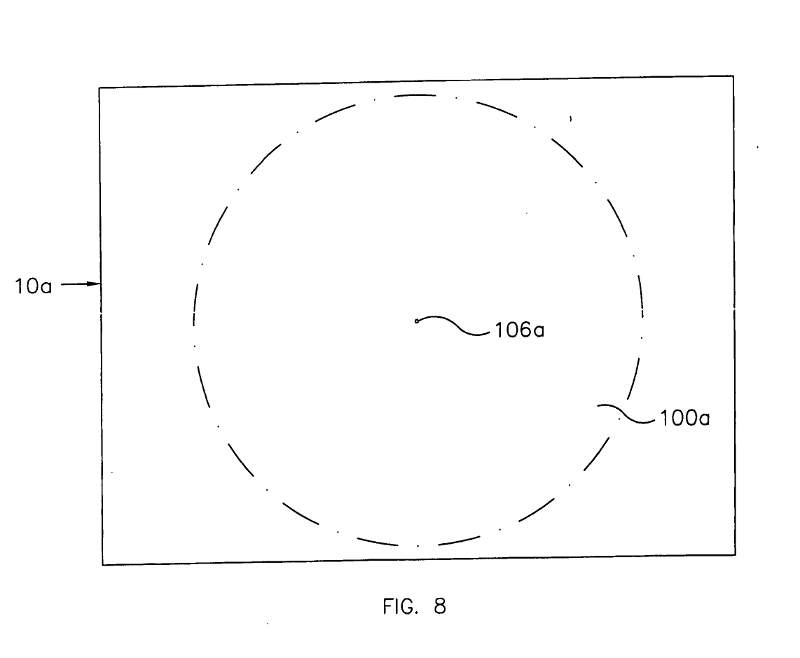

A plurality of the photoluminescent fibers are then mechanically entangled with the use of barbed needles with a range of about 50 to 2500 penetrations per square inch of fabric. An exemplary final sheet product 10a, as shown in FIG. 8, may have a weight from about 8 to 16 ounces per square yard and a thickness from about 1/16 to ⅛ of an inch. In one embodiment, the sheet of material is 72 inches×100 yards, but may be any other suitable size such as for an interior of a vehicle. Typically, the sheet of photoluminescent felt material 10a is photoluminescent for a period of up to about 12 hours once fully charged.

Once formed, as shown previously in FIG. 2, the formed sheet of photoluminescent felt material 10a can be die-cut to form at least one photoluminescent turntable mat 100a. In one embodiment, felt material is cut into the shape of photoluminescent turntable mat 100a having a diameter of 1-1¾ inches. Aperture 106 is preferably cut from the center of sheet 10a with a diameter of about ⅛ of an inch such that photoluminescent turntable mat 100 may be placed over a spindle of a turntable and used as a protective surface buffering the phonorecord from the turntable.

Visual indicia 110, such as logos, designs, business information, or the like can be provided on a surface of the photoluminescent turntable mat using conventional screen-printing, dye sublimation, or any other suitable method, as shown in FIG. 2. Sublimation, however, is the preferred method for this invention as it offers two distinct advantages. First, dye sublimation allows for full color printing. Second, dye sublimation leaves the surface of the sublimated piece residue free minimizing the chances a phonorecord is scratched.

Dye sublimation is a unique process that uses a special heat sensitive dye to provide visual indicia such as pictorial images or text images such as business information, phone numbers, websites, or other information onto a coated with inkjet transfer paper. At high temperatures, typically in the range of about 350° F. to about 400° F., the sublimation ink converts from a solid to a gas without passing through a liquid state. At the same time, the high temperature opens the pores of the felt substrate allowing the gas to enter the felt substrate. As the temperature decreases, the pores close and the gas reverts to a solid state. The transfer paper has a special coating, typically a silicone or polymer base, that does not allow the sublimation ink to absorb into the paper.

To initiate the sublimation process, the transfer paper is placed over the photoluminescent felt material in a heat press and heated to between about 350° F. to about 400° F., and preferably to about 400° F., at a pressure of one ounce to five pounds per square inch, for about 30 to 40 seconds depending on the felt substrate base (nylon, polypropylene or polyester). Any suitable heat press may be used in the present invention, such as for example, a DK 20S 16×20 Digital Swinger heat press made by Geo Knight & Co. Inc. Brockton, Mass. The image is transferred, initiated by heat, and controlled with pressure and time, to the photoluminescent felt material forming part of its surface by any typical laminating press known in the art. After transfer of the image, no residue remains on the surface of the substrate and it is undetectable by touch. Once removed, the product is considered finished and ready for packaging and sale.

### EXAMPLE 2

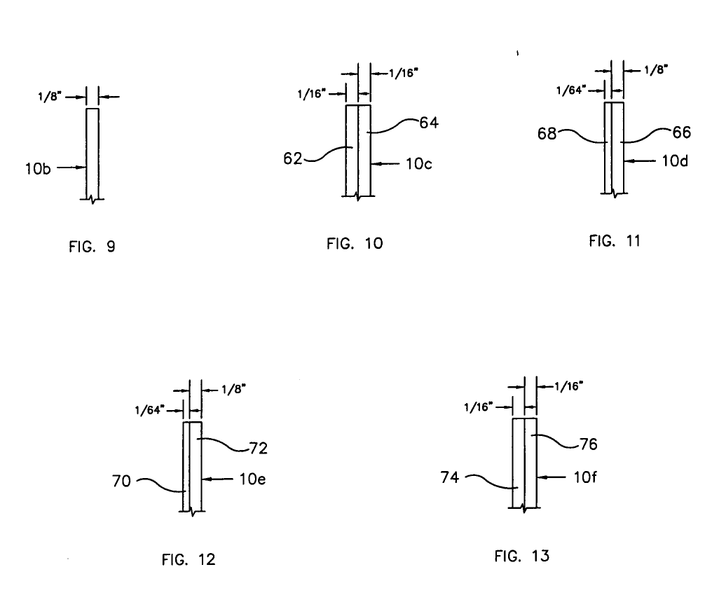

A non-woven felt substrate material is immersed in an aqueous photoluminescent solution containing photoluminescent pigments ranging between about 5 μm and 80 μm. Once saturated with the photoluminescent solution, the felt substrate is pressed between two rollers and dehydrated. The felt is thereafter removed and laid out to dry. The aqueous photoluminescent solution enables the photoluminescent pigment to adhere to the felt material. Once saturated removed and dried, a non-woven sheet 10b of photoluminent felt material is produced as shown in FIG. 9. Typically, the sheet 10b is about ⅛ inch in thickness. Optionally, the sheet 10b of photoluminescent felt material may be die cut to form into a photoluminescent phonorecord mat and sublimated on as provided in Example 1 above.

### EXAMPLE 3

A photoluminescent pigment mixture comprising a photoluminescent pigment and a resin is dispensed on a surface of the felt substrate by a suitable dispensing apparatus as known in the art. The resin acts as a binding agent for the photoluminescent pigment. The felt substrate may be any one of nylon, polypropylene, polyester, cotton non-woven felt substrate, or any other suitable felt material. Once the photoluminescent pigment is applied, the felt substrate is laminated by moving the felt substrate through a suitable heating device as known in the art which is set at a temperature between about 150° F. and about 450° F., depending on the resin consistency. The temperature is preferably set to a temperature close to the melting point of the resin such that the laminating process bonds the photoluminescent component coated on the resin with the felt substrate and traps the photoluminescent pigment inside a melted resin layer to form a sheet of photoluminescent felt material 10c, as shown in FIG. 10. The photoluminescent felt material 10c has a photoluminescent resin layer 62 which is about 1/16 inch in thickness and a felt layer 64 which is about 1/16 inch in thickness.

Optionally, the resultant photoluminescent felt 10c can be die cut into a photoluminescent phonorecord mat as detailed in Example 1. It is understood in this embodiment, any sublimation, screen-printing, or other method of providing indicia on the felt substrate may be performed before the resin based powder is applied. First providing indicia, preferably by sublimation, prior to applying the photoluminescent pigment mixture ensures the highest quality product, and leaves the final product with a relatively smooth surface.

### EXAMPLE 4

A photoluminescent pigment is sprayed on a surface of a felt substrate using any suitable spraying apparatus, such as a EM-C3 Airmatic spraygun made by Wagner Systems, Inc. Carol Stream, Ill. Thereafter, the applied photoluminescent pigment and felt substrate are laminated using a transfer paper. Preferably, the photoluminescent pigment has a particle size in the range between about 20 μm and about 80 μm and is evenly dispersed over nylon, polypropylene, polyester or cotton non-woven felt substrate. Alternatively, the felt substrate may be any other suitable material.

The photoluminescent felt and transfer paper are heated at about 350° F. degrees at a pressure of one ounce to five pounds per square inch, for approximately 10-30 seconds, and preferably about 15 seconds. When the laminating is complete, both the thermal-wax coating and indicia transfer to the felt substrate leaving a protective layer yielding a sheet of photoluminescent material 10d, as shown in FIG. 11, having a felt material layer 66 about ⅛ inch in thickness and a thermal wax transfer paper coating layer 68 about 1/64 inch in thickness.

Optionally, the produced photoluminescent felt material 10d may be die cut into a photoluminescent turntable mat and sublimated on by the sublimation process set forth in Example 1 to provide artwork, logos, business contact information, and the like on a surface of the mat. However, instead of using the silicone or polymer coated transfer paper in the laminating step as described in Example 1, a thermal-wax coated transfer paper may be used to ensure the photoluminescent pigment is locked inside the felt substrate. For other applications that do not require the photoluminescent felt material to be sublimated on, the powder coating method as described in Example 3 may also be utilized.

### EXAMPLE 5

A photoluminescent paper is laminated to a felt substrate to form a sheet of photoluminescent material by any suitable apparatus known in the art. The photoluminescent paper is preferably a thermal wax-coated photoluminescent transfer paper which may be used to transfer any indicia to a felt substrate by way of the sublimation process as described in Example 4. The felt substrate is typically a nylon, polypropylene, polyester, or cotton, non-woven felt substrate. As shown in FIG. 12, the resulting sheet of photoluminescent material 10e includes a felt substrate layer 70 which is typically about ⅛″ in thickness and a photoluminescent thermal wax transfer paper 72 which is typically about 1/64″ inch in thickness.

To complete the sublimation of the visual indicia onto the felt material and transfer the photoluminescent component to the felt substrate, the photoluminescent paper is placed over the photoluminescent felt material in a heat press and heated to between about 350° F. to about 400° F., and preferably to about 350° F., at a pressure of one ounce to five pounds per square inch, for about 30 to 40 seconds, preferably about 25 seconds, depending on the material used for the transfer paper. The image is transferred, initiated by heat, and controlled with pressure and time, from the photoluminescent paper to the photoluminescent felt substrate forming part of its surface. After transfer of the image, no residue remains on the surface of the felt substrate and it is undetectable by touch. Once removed, the photoluminescent felt material product is considered finished and ready for packaging and sale.

Optionally, as recited in each example, a photoluminescent turntable mat may be formed by die-cutting the resultant photoluminescent felt material product. In one embodiment, the produced photoluminescent felt material is cut into the shape of a circle having a diameter of 1-1¾ inches. Additionally, an aperture is cut from the center of the circle with a diameter of ⅛ of an inch to form a photoluminescent slipmat. The photoluminescent turntable mat is adapted to be placed over the spindle of a turntable and used as a protective surface buffering the phonorecord from the turntable.

### EXAMPLE 6

In yet another embodiment, the step of incorporating the photoluminescent component into the felt substrate sheet comprises adhering a photoluminescent film to the felt substrate using any suitable adhesive known in the art, such as a vinyl-adhesive. The photoluminescent plastic film includes a photoluminescent pigment, preferably activated by strontium aluminate, and preferably has an adhesive on one side thereof. The film is affixed by any suitable adhesive to a nylon, polypropylene, polyester or cotton non-woven felt substrate to produce a sheet of a photoluminescent material 10f, as shown in FIG. 13, which includes a photoluminescent film layer 74 of about 1/16 ″ in thickness and a felt substrate layer 76 of about 1/16 ″ in thickness.

Optionally, the resulting photoluminescent felt material product may be die-cut into a photoluminescent turntable mat and sublimated on as detailed in Example 1. To initiate the sublimation step, a digital dye-sublimination transfer paper is placed over the photoluminescent felt material in a heat press and heated to between about 350° F. to about 400° F., and preferably to about 350° F., at a pressure of one ounce to five pounds per square inch, for about 15 seconds. The image is transferred, initiated by heat, and controlled with pressure and time, to the photoluminescent felt material forming part of its surface. After transfer of the image, no residue remains on the surface of the substrate and it is undetectable by touch. Once removed, the product is considered finished and ready for packaging and sale.

In yet another novel aspect of the present invention, the method comprises providing a relatively frictionless surface on at least one of the top and bottom surfaces, and preferably the bottom surface, of the turntable slipmat for reducing friction between the photoluminescent mat and a turntable when in use. Typically, the providing of the relatively frictionless surface is accomplished by subjecting the at least one surface to heat at a temperature above the melting point of the felt substrate material for a sufficient period of time to form a relatively frictionless surface, which may have the appearance of a glaze, on at least one of the top and bottom surfaces of the turntable slipmat.

In still another novel aspect of the present invention, the method comprises substantially coating at least one surface of the photoluminescent slipmat with silicone or any other suitable material for reducing friction between the photoluminescent mat and a turntable when in use.

In making a photoluminescent slipmat in accordance with the present invention, it is understood that the disc may be die-cut from an intermediate photoluminescent felt sheet material product made from any of the methods described herein in Examples 1-6. Alternatively, the felt substrate may initially be in the form of a flexible disc and the photoluminescent component is incorporated into the flexible disc to form the photoluminescent slipmat.

Further optionally, visual indicia may be provided on a surface of the photoluminescent film. To do so, transfer paper is placed over the photoluminescent felt material in a heat press and heated to between about 350° F. to about 400° F., and preferably to about 350° F., at a pressure of one ounce to five pounds per square inch, for about 15 seconds. The image is transferred, initiated by heat, and controlled with pressure and time, to the photoluminescent disc forming part of a surface of the photoluminescent film. After transfer of the image, no residue remains on the surface of the disc and it is undetectable by touch. Once removed, the photoluminescent disc is considered finished and ready for packaging and sale.

While the invention has been described with respect to certain preferred embodiments, it is to be understood that the invention is capable of numerous changes, modifications, and rearrangements without departing from the scope or spirit of the invention as defined in the claims.

1. A photoluminescent felt material comprising:
a felt substrate sheet having a first and a second surface; and
a photoluminescent component incorporated with said felt substrate.

2. The photoluminescent felt material of claim 1 wherein said photoluminescent component is a photoluminescent fiber.

3. The photoluminescent felt material of claim 1 wherein said photoluminescent material is a photoluminescent film laminated to said substrate.

4. The photoluminescent felt material of claim 1 wherein said photoluminescent material comprises a photoluminescent pigment.

5. The photoluminescent felt material of claim 1 wherein said photoluminescent material is photoluminescent paper.

6. A photoluminescent slipmat for a turntable comprising:
a disc of a flexible substrate material; and
a photoluminescent component incorporated with said flexible substrate material.

7. The photoluminescent slipmat of claim 6 wherein said flexible substrate material comprises a felt material.

8. The photoluminescent slipmat of claim 7 wherein said photoluminescent component comprises a photoluminescent fiber.

9. The photoluminescent slipmat of claim 7 wherein said photoluminescent component comprises a photoluminescent film, said photoluminescent film being laminated to said felt material.

10. The photoluminescent slipmat of claim 7 wherein said photoluminescent material comprises a photoluminescent pigment.

11. The photoluminescent slipmat of claim 7 wherein said photoluminescent material comprises photoluminescent paper.

12. The photoluminescent slipmat of claim 6 wherein said flexible substrate comprises photoluminescent film.

13. The photoluminescent slipmat of claim 6 wherein at one least one surface of said disc comprises a relatively frictionless surface.

14. A method of making a photoluminescent felt material comprising:
providing a felt substrate sheet having a top surface and a bottom surface; and
incorporating a photoluminescent component with said felt substrate sheet to produce a sheet of photoluminescent felt material.

15. The method of claim 14 wherein said photoluminescent component is a photoluminescent film, and wherein said incorporating comprises adhering said photoluminescent film to said felt substrate sheet.

16. The method of claim 14 wherein said photoluminescent component comprises a photoluminescent pigment, and wherein said incorporating comprises:
forming a mixture of the photoluminescent pigment and a solvent;
impregnating said substrate within said mixture; and
evaporating said solvent.

17. The method of claim 14 wherein said photoluminescent component comprises photoluminescent paper, and wherein said incorporating comprises laminating said photoluminescent paper to said substrate.

18. The method of claim 14 wherein said photoluminescent component comprises a photoluminescent pigment, and wherein said incorporating comprises:
applying said photoluminescent pigment to at least one of the top and bottom surfaces of said substrate; and
laminating said pigment to said substrate.

19. The method of claim 14 wherein said photoluminescent component comprises a photoluminescent pigment and resin mixture and wherein said incorporating comprises applying said mixture to at least one of the top and bottom surfaces of said substrate; and
laminating said mixture to said substrate.

20. A method of making a photoluminescent material comprising providing a first fiber, and a second fiber having a photoluminescent component; and
needle punching said first fiber and said second fiber to form a sheet of photoluminescent-felt material.

21. The method of claim 20 further comprising forming said sheet of photoluminescent-felt material into at least one photoluminescent disc adapted to be used on a turntable.

22. A method of making a photoluminescent slipmat comprising:
providing a disc comprising a flexible substrate; and
incorporating a photoluminescent component into said disc.

23. The method of claim 22 wherein said substrate comprises a felt material.

24. The method of claim 23 wherein said photoluminescent component comprises a photoluminescent film, and wherein said incorporating comprises adhering said photoluminescent film to said felt material.

25. The method of claim 23 wherein said photoluminescent component comprises a photoluminescent pigment, and wherein said incorporating comprises:
forming a mixture of the photoluminescent pigment and a solvent;
impregnating said felt material with said mixture; and
evaporating said solvent.

26. The method of claim 23 wherein said photoluminescent component is photoluminescent paper, and wherein said incorporating comprises laminating said photoluminescent paper to said felt material.

27. The method of claim 23 wherein said photoluminescent component comprises a photoluminescent pigment, and wherein said incorporating comprises:
applying said photoluminescent pigment on at least one of said top and a bottom surfaces of said felt material; and
laminating said pigment to said felt material.

28. The method of claim 23 wherein said photoluminescent component comprises a photoluminescent pigment, and wherein said incorporating comprises:
applying said photoluminescent pigment to at least one of the top and bottom surfaces of said substrate; and
laminating said mixture to said substrate.

29. The method of claim 23 further comprising heating at least one surface of said felt substrate to a temperature above a melting point of the substrate so as to form a relatively frictionless surface on said at least one surface.
